(19) United States
(12) Patent Application Publication
(10) Pub. No.: US 2026/0322989 A1
(43) Pub. Date: Oct. 15, 2026

(54) TWO-DIMENSIONAL AND THREE-DIMENSIONAL DISPLAY APPARATUS AND ELECTRONIC APPARATUS INCLUDING THE SAME

(71) Applicant: SAMSUNG ELECTRONICS CO., LTD., Suwon-si (KR)

(72) Inventors: Bongsu SHIN, Suwon-si (KR); Juwon SEO, Suwon-si (KR); Changkun LEE, Suwon-si (KR)

(73) Assignee: SAMSUNG ELECTRONICS CO., LTD., Suwon-si (KR)

(21) Appl. No.: 19/696,466

(22) Filed: Jun. 3, 2026

Related U.S. Application Data
(63) Continuation of application No. PCT/KR2026/002063, filed on Feb. 4, 2026.

(30) Foreign Application Priority Data
Feb. 7, 2025 (KR) 10-2025-0016156

(51) Int. Cl. H04N 13/359; G02F 1/1335; G02F 1/13363; H04N 13/305

(52) U.S. Cl. CPC H04N 13/359; G02F 1/133526; G02F 1/133638; H04N 13/305

(57) ABSTRACT

A two-dimensional (2D) and three-dimensional (3D) display apparatus including a display device including a first region configured to display a 2D image and a second region configured to display a 3D image. The display apparatus including an image controller configured to independently turn on and off the first region and the second region. The display apparatus including an optical device including a transmission unit configured to transmit the 2D image and a separation unit configured to separate viewing zones for the 3D image. The transmission unit and the separation unit are configured as passive type components. The first region and the second region do not overlap. The transmission unit faces the first region, and the separation unit faces the second region.

### CROSS-REFERENCE TO RELATED APPLICATIONS

This application is a continuation of International Application PCT/KR 2026/002063, filed on Feb. 4, 2026, which is based on and claims priority to Korean Patent Application No. 10-2025-0016156, filed on Feb. 7, 2025, in the Korean Intellectual Property Office, the disclosure of which is incorporated by reference herein in their entireties.

### BACKGROUND

### 1. Field

Embodiments of the disclosure relate to a two-dimensional (2D) and three-dimensional (3D) display apparatus and an electronic apparatus including the same.

### 2. Description of the Related Art

In general, three-dimensional (3D) images are created based on the principle of stereoscopic vision through a person's eyes, and the binocular parallax that occurs because the eyes are separated from each other by about 65 mm. The binocular parallax is considered a crucial factor in creating a sense of depth. A sense of depth may be represented by showing each of a person's two eyes the same scene as actually perceived by the eyes. To achieve this, two identical cameras are positioned apart at the same distance as that between the two eyes and are used to capture images. An image captured by the left camera is then shown only to the left eye, while an image captured by the right camera is shown only to the right eye. 3D image display apparatuses may be embodied as glasses-based displays and glasses-free displays. Glasses-based displays include displays using polarized glasses or shutter glasses. Glasses-free displays include displays using a parallax barrier, a lenticular lens system, integral imaging, or holography.

The background technology described above is technical information that the inventor possessed for deriving the disclosure or acquired in the process of deriving the disclosure and therefore cannot necessarily be considered as prior art publicly disclosed before the filing of the disclosure.

### SUMMARY

According to an embodiment of the disclosure, a two-dimensional (2D) and 3D display apparatus capable of switching between a 2D image and a 3D image without electrical driving is provided.

According to an embodiment of the disclosure, there is provided an electronic apparatus including the 2D and 3D display apparatus capable of switching between a 2D image and a 3D image without electrical driving.

According to an embodiment of the disclosure, a two-dimensional (2D) and three-dimensional (3D) display apparatus including a display device including a first region configured to display a 2D image and a second region configured to display a 3D image. The display apparatus includes an image controller configured to independently turn on and off the first region and the second region. The display apparatus includes an optical device including a transmission unit configured to transmit the 2D image and a separation unit configured to separate viewing zones for the 3D image. The transmission unit and the separation unit are configured as passive type components. The first region and the second region do not overlap. The transmission unit faces the first region, and the separation unit faces the second region.

In an embodiment, the separation unit of the optical device includes a gradient index lens, a holographic optical element, or a microlens array.

In an embodiment, the optical device includes a patterned retarder, a lenticular lens array on the patterned retarder, and a liquid crystal lenticular lens array on the lenticular lens array, or the optical device includes a patterned retarder, a liquid crystal lenticular lens array on the patterned retarder, and a lenticular lens array on the liquid crystal lenticular lens array.

In an embodiment, the patterned retarder includes a transparent portion corresponding to the first region and a half-wave plate corresponding to the second region.

In an embodiment, the patterned retarder includes a plurality of odd-numbered lines and a plurality of even-numbered lines, the transparent portion is on the plurality of odd-numbered lines, and the half-wave plate is on the plurality of even-numbered lines.

In an embodiment, the patterned retarder includes a first patterned retarder and a second patterned retarder on the first patterned retarder, the first patterned retarder includes a first quarter-wave plate corresponding to the first region, and a second negative quarter-wave plate corresponding to the second region, and the second patterned retarder includes quarter-wave plates corresponding to the first region and the second region.

In an embodiment, the lenticular lens array has a first refractive index, and the liquid crystal lenticular lens array has the first refractive index or a second refractive index depending on a polarization state of incident light.

In an embodiment, the lenticular lens array includes a plurality of lenticular lenses, and the plurality of lenticular lenses are tilted at an angle greater than 0° and less than 90° with respect to a horizontal direction.

In an embodiment, the lenticular lens array has a convex lens shape facing upward or a concave lens shape facing downward.

In an embodiment, the liquid crystal lenticular lens array has a shape opposite to that of the lenticular lens array and is combined with the lenticular lens array without intervention of another layer.

In an embodiment, the first region and the second region are arranged randomly.

According to an embodiment of the disclosure, an electronic apparatus includes: a display apparatus; speaker; a sensor; and a camera. The display apparatus includes a display device including a first region configured to display a two-dimensional (2D) image and a second region configured to display a three-dimensional (3D) image, an image controller configured to independently turn on and off the first region and the second region, and an optical device including a transmission unit configured to transmit the 2D image and a separation unit configured to separate viewing zones for the 3D image. The transmission unit and the separation unit are configured as passive type components. The first region and the second region are arranged so as not to overlap. The transmission unit faces the first region, and the separation unit faces the second region.

In an embodiment, the separation unit of the optical device includes a gradient index lens, a holographic optical element, or a microlens array.

In an embodiment, the optical device includes a patterned retarder, a lenticular lens array on the patterned retarder, and a liquid crystal lenticular lens array on the lenticular lens array, or the optical device includes a patterned retarder, a liquid crystal lenticular lens array on the patterned retarder, and a lenticular lens array on the liquid crystal lenticular lens array.

In an embodiment, the patterned retarder includes a transparent portion corresponding to the first region and a half-wave plate corresponding to the second region.

In an embodiment, the patterned retarder includes a plurality of odd-numbered lines and a plurality of even-numbered lines, the transparent portion is on the plurality of odd-numbered lines, and the half-wave plate is on the plurality of even-numbered lines.

In an embodiment, the patterned retarder includes a first patterned retarder and a second patterned retarder on the first patterned retarder, the first patterned retarder includes a first quarter-wave plate corresponding to the first region, and a second negative quarter-wave plate corresponding to the second region, and the second patterned retarder includes quarter-wave plates corresponding to the first region and the second region.

In an embodiment, the lenticular lens array has a first refractive index, and the liquid crystal lenticular lens array has the first refractive index or a second refractive index depending on a polarization state of incident light.

In an embodiment, the lenticular lens array includes a plurality of lenticular lenses, and the plurality of lenticular lenses are tilted at an angle greater than 0° and less than 90° with respect to a horizontal direction.

In an embodiment, the lenticular lens array has a convex lens shape facing upward or a concave lens shape facing downward.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A illustrates a two-dimensional (2D) image being displayed on a 2D and three-dimensional (3D) display apparatus, according to an embodiment of the disclosure.

FIG. 1B illustrates a 3D image being displayed on a 2D and 3D display apparatus, according to an embodiment of the disclosure.

FIG. 2 illustrates an example in which a first region and a second region of a 2D and 3D display apparatus are partitioned obliquely, according to an embodiment of the disclosure.

FIG. 3 illustrates an example in which a first region and a second region of a 2D and 3D display apparatus are partitioned along vertical lines, according to an embodiment of the disclosure.

FIG. 4 illustrates an example in which a first region and a second region of a 2D and 3D display apparatus are partitioned in units of pixels, according to an embodiment of the disclosure.

FIG. 5 illustrates an example in which a 2D image and a 3D image are displayed together on a 2D and 3D display apparatus, according to an embodiment of the disclosure.

FIG. 6 illustrates a 2D and 3D display apparatus according to an embodiment of the disclosure.

FIG. 7 illustrates a 2D image being displayed on the 2D and 3D display apparatus of FIG. 6, according to an embodiment of the disclosure.

FIG. 8 illustrates a 3D image being displayed on the 2D and 3D display apparatus of FIG. 6, according to an embodiment of the disclosure.

FIG. 9 illustrates an example in which the positions of a lenticular lens array and a liquid crystal lenticular lens array are switched compared with those illustrated in FIG. 6, according to an embodiment of the disclosure.

FIG. 10A illustrates a 2D and 3D display apparatus displaying a 2D image, according to an embodiment of the disclosure.

FIG. 10B illustrates a 2D and 3D display apparatus displaying a 3D image, according to an embodiment of the disclosure.

FIG. 11A illustrates a first region and a second region of a 2D and 3D display apparatus being partitioned into odd-numbered lines and even-numbered lines to display a 2D image, according to an embodiment of the disclosure.

FIG. 11B illustrates a first region and a second region of a 2D and 3D display apparatus being partitioned into odd-numbered lines and even-numbered lines to display a 3D image, according to an embodiment of the disclosure.

FIG. 12 illustrates an example in which lenticular lenses are arranged obliquely relative to a horizontal direction in the 2D and 3D display apparatus illustrated in FIG. 11A, according to an embodiment of the disclosure.

FIG. 13 illustrates an electronic apparatus according to an embodiment of the disclosure.

FIG. 14 is a block diagram of an electronic apparatus according to an embodiment of the disclosure.

### DETAILED DESCRIPTION

Hereinafter, a two-dimensional (2D) and three-dimensional (3D) display apparatus and an electronic apparatus including the same, according to various embodiments of the disclosure, will be described in detail with reference to the attached drawings. In the drawings below, the same reference numerals refer to the same components, and the size of each component in the drawings may be exaggerated for clarity and convenience of description. Although the terms, such as “first”, “second”, etc., may be used herein to describe various elements or components, these elements or components should not be limited by the terms. The terms are only used to distinguish one element or component from another element or component.

Singular expressions used herein are intended to include plural expressions as well unless the context clearly indicates otherwise. Furthermore, when a part “includes” or “comprises” an element, unless there is a particular description contrary thereto, it is understood that the part may further include other elements, not excluding the other elements. In addition, the size or thickness of each component in the drawing may be exaggerated for clarity of description. Furthermore, when a certain material layer is described as being disposed on a substrate or another layer, it should be understood that the material layer may be disposed directly on the substrate or the other layer, or that a third layer may be provided therebetween. It should be also understood that materials forming each layer in the following embodiment of the disclosure are merely examples, and other materials may also be used.

As terms used in embodiments of the specification, general terms that are currently widely used are selected by taking into account the functions in the disclosure, but these terms may vary according to the intention of those skilled in the art, precedent cases, advent of new technologies, etc. Furthermore, specific terms may be arbitrarily selected by the applicant, and in this case, the meaning of the selected terms will be described in detail in the description of a corresponding embodiment of the disclosure. Thus, the terms used herein should be defined not by simple appellations thereof but based on the meaning of the terms together with the overall description of the disclosure.

Unless the context clearly indicates otherwise, the singular forms “a, “an,” and “the” are to be understood to include a plurality of referents. Thus, for example, reference to “a component surface” may also include reference to one or more of such surfaces.

All the terms used herein, which include technical or scientific terms, may have the same meaning that is generally understood by a person of ordinary skill in the art.

Furthermore, in the disclosure, it should be understood that when a component is referred to as being “connected” or “coupled” to another component, the component may be directly connected or coupled to the other component, but may also be connected or coupled to the other component via another intervening component therebetween unless there is a particular description contrary thereto.

Unless specifically stated otherwise in the disclosure, “or” is inclusive and not exclusive. Therefore, unless clearly indicated otherwise or unless the context indicates otherwise, “A or B” may indicate only A, only B, and both A and B. In the disclosure, the expression “at least one of . . . ” or “one or more of . . . ” may mean that different combinations of one or more of the listed items may be used, or that only any one of the listed items is required. For example, the expression “at least one of A, B or C” may include any of the following combinations: only A, only B, only C, both A and B, both A and C, both B and C, or all of A, B, and C, or variations thereof.

Throughout the disclosure, when a part “includes” or “comprises” an element, unless there is a particular description contrary thereto, it is understood that the part may further include other elements, not excluding the other elements. Furthermore, terms, such as “unit,” “module,” etc., used herein indicate a unit for processing at least one function or operation, and may be implemented as hardware or software or a combination of hardware and software.

The expression “configured to (or set to)” used herein may be used interchangeably, according to context, with the expression such as “suitable for,” “having the capacity to,” “designed to,” “adapted to,” “made to,” or “capable of”. The term “configured to (or set to)” may not necessarily mean only “specifically designed to” in terms of hardware. Instead, the expression “a system configured to” may mean, in some contexts, the system being “capable of”, together with other devices or components. For example, the expression “a processor configured to (or set to) perform A, B, and C” may mean a dedicated processor (e.g., an embedded processor) for performing the corresponding operations, or a general-purpose processor (e.g., a central processing unit (CPU) or an application processor (AP)) capable of performing the corresponding operations by executing one or more software programs stored in a memory.

In the disclosure, the processor is a component that controls a series of processes to cause an electronic apparatus to operate according to embodiments of the disclosure as described below, and may consist of one or a plurality of processors. The one or plurality of processors included in the processor may be circuitry, such as a system on chip (SoC), an integrated circuit (IC), etc. The one or plurality of processors included in the processor may be a general-purpose processor such as a CPU, a microprocessor unit (MPU), an AP, a digital signal processor (DSP), etc., a dedicated graphics processor such as a graphics processing unit (GPU) and a vision processing unit (VPU), a dedicated artificial intelligence (AI) processor such as a neural processing unit (NPU), or a dedicated communication processor such as a communication processor (CP). When the one or the plurality of processors included in the processor is a dedicated AI processor, the dedicated AI processor may be designed with a hardware structure specialized for processing a particular AI model.

In the disclosure, the processor may include various types of processing circuitry and/or a plurality of processors. For example, the term “processor” as used herein, including that in the claims, may include various types of processing circuitry including at least one processor. One or more of the at least one processor, individually and/or collectively in a distributed form, may be configured to perform various functions described herein. As used herein, “a processor,” “at least one processor,” and “one or more processors” may be configured to perform various functions. However, these terms cover, without limitation, situations in which one processor performs some of recited functions and another processor (other processors) perform other functions, as well as situations in which a single processor may perform all of the recited functions. Furthermore, the at least one processor may include a combination of processors that perform various functions among the recited functions in a distributed manner. The at least one processor may execute program instructions to accomplish or perform various functions.

The processor may write data to the memory or read data stored in the memory, and in particular, execute a program or at least one instruction stored in the memory to process data according to predefined operation rules or AI models. Thus, the processor may perform operations according to embodiments of the disclosure as described below, and the operations described as being performed by the electronic apparatus or components included in the electronic apparatus in the embodiments of the disclosure as described below may be considered as being performed by the processor unless otherwise specified.

It should be understood that blocks in each flowchart and combinations of flowcharts in the disclosure may be performed by one or more computer programs including computer-executable instructions. The one or more computer programs may be all stored in a single memory, or may be partitioned and stored in a number of different memories.

All functions or operations described herein may be processed by a single processor or a combination of processors. The processor or combination of processors is circuitry that performs processing, and may include circuitry such as an AP, a CP, a GPU, an NPU, an MPU, a SoC, and an integrated chip (or IC).

Each block in flowchart illustrations and combinations of blocks in the flowchart illustrations may be performed by computer program instructions. Because these computer program instructions may be loaded into a processor of a general-purpose computer, a special-purpose computer, or other programmable data processing equipment, the instructions, when executed by the processor of the computer or the other programmable data processing equipment, may generate a unit for performing functions specified in the flowchart block(s). The computer program instructions may also be stored in a computer-executable or computer-readable memory capable of directing the computer or the other programmable data processing equipment to implement functions in a specific manner, such that the instructions stored in the computer-executable or computer-readable memory are capable of producing an article of manufacture including instructions for performing the functions specified in the flowchart block(s). These computer program instructions may also be loaded onto the computer or the other programmable data processing equipment to cause a series of operations to be performed on the computer or other programmable data processing equipment to produce a process executed by the computer, such that the instructions, when executed by the computer or other programmable data processing equipment, provide operations for implementing the functions specified in the flowchart block(s).

In addition, each block of a flowchart may represent a module, segment, or portion of code that includes one or more executable instructions for executing specified logical function(s). Additionally, it should be noted that, in some alternative embodiments of the disclosure, functions mentioned in blocks may occur out of order. For example, two blocks illustrated in succession may be executed substantially simultaneously, or the blocks may sometimes be executed in reverse order depending on functions corresponding thereto.

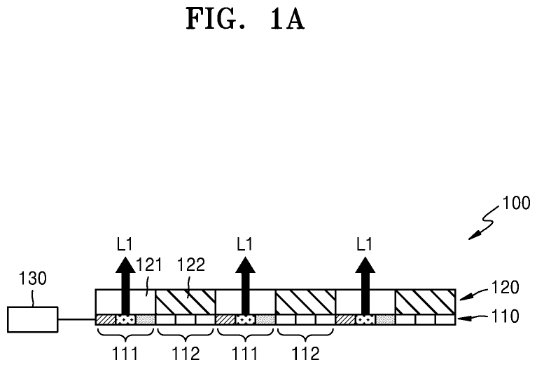

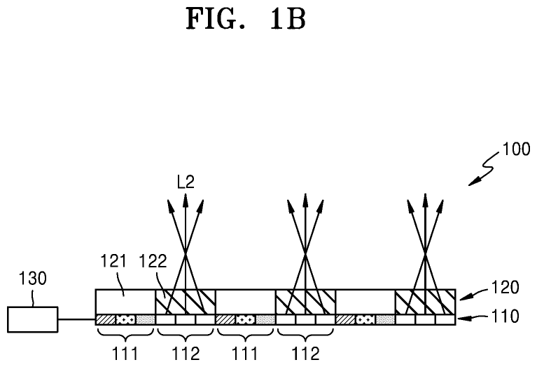

FIGS. 1A and 1B schematically illustrate a 2D and 3D display apparatus according to an embodiment of the disclosure.

A 2D and 3D display apparatus (hereinafter referred to as a display apparatus) 100 includes a display device 110 including a first region 111 for displaying a 2D image and a second region 112 for displaying a 3D image, an image controller 130 for inputting an image signal to the display device 110, and an optical device 120 including a transmission unit 121 that transmits the 2D image and a separation unit 122 that separates viewing zones for the 3D image. In some embodiments, the display device 110 includes a plurality of first regions 111 and a plurality of second regions 112.

The display device 110 may include a liquid crystal display (LCD), a field emission display (FED), a plasma display panel (PDP), a light-emitting diode (LED) display, an organic LED (OLED) display, or an electrophoretic display (EPD). The display device 110 may further include a polarizing element that converts the polarization of image light as needed. For example, when the display device 110 includes an OLED display device, the display device 110 may include an OLED and a polarizing element that converts light emitted from the OLED into polarized light.

The image controller 130 may independently turn on and off the first region 111 and the second region 112. The first region 111 and the second region 112 may be positioned so that they do not overlap. The first region 111 and the second region 112 may be arranged alternately, and an arrangement pitch, arrangement orientation, areas of the first region 111 and the second region 112, etc., may be varied in various ways. The display device 110 may include a plurality of pixels as basic units for displaying color, and the first region 111 and the second region 112 may each be arranged in units of a single pixel, in units of a plurality of pixels, or in units of lines. However, the arrangement of the first region 111 and the second region 112 is not limited thereto.

The image controller 130 may control the display device 110 to display a 2D image by turning on pixels in the first region 111 and turning off pixels in the second region 112, or to display a 3D image by turning on the pixels in the second region 112 and turning off the pixels in the first region 111. Alternatively, the image controller 130 may control the display device 110 to simultaneously display both a 2D image and a 3D image by turning on at least a portion of the pixels in the first region 111 and turning on at least a portion of the pixels in the second region 112. The image controller 130 may control the display device 110 to switch between a 2D image and a 3D image, or to display a 2D image in one region of a display screen and a 3D image in another region of the display screen.

The image controller 130 may be implemented using a processor and/or a specialized electronic circuit including logic circuitry configured to process image data in real-time. For example, the image controller 130 may include a central processing unit (CPU) or application-specific integrated circuit (ASIC) in communication with a non-transitory memory storing a spatial mapping table that defines coordinates for the first region 111 and the second region 112. The image controller 130 may further include a data routing demultiplexer and gating logic configured to selectively enable or disable data paths to specific pixel addresses within the display device 110 based on the input signal type (2D input data or 3D input data). Additionally, the image controller 130 may include a timing generator (e.g., a timing controller) that synchronizes the activation of the first region 111 and the second region 112 with a refresh rate of the display device 110. By utilizing these hardware components, the image controller 130 may transform received image signals into discrete drive voltages applied to specific pixel electrodes of the respective first and second regions 111 and 112.

In some embodiments, the transmission unit 121 and separation unit 122 of the optical device 120 may be configured as passive type components. A passive type component may refer to a component that operates without electrical driving. Therefore, no power may be consumed by the optical device 120 during an operation of switching between a 2D image and a 3D image. The transmission unit 121 of the optical device 120 may transmit image light emitted from the display device 110 without directionality or directivity, thereby allowing a 2D image to be displayed. The separation unit 122 of the optical device 120 may separate viewing zones by outputting the image light emitted from the display device 110 with directionality, thereby allowing a 3D image to be displayed. The transmission unit 121 may be arranged to face the first region 111, and the separation unit 122 may be arranged to face the second region 112.

The transmission unit 121 may include a transparent material. The transmission unit 121 may include, for example, glass. The transmission unit 121 may display a 2D image by directing and transmitting incident light.

The separation unit 122 may include a refractive index modulation element, a holographic optical element, or a microlens array. The refractive index modulation element may be, for example, a gradient index (GRIN) lens. A GRIN lens may have a refractive index gradient such that a central portion has a relatively high refractive index and the refractive index gradually decreases radially outward. The GRIN lens may converge light to a specific focal length, functioning like a convex lens. Thus, the separation unit 122 may separate the incident light into multiple output directions depending on an incident angle of the light.

The optical device 120 may have a flat shape and a small thickness. Therefore, according to an embodiment of the disclosure, the display apparatus 100 may be included in, for example, a mobile phone. While an optical device having a physically convex shape may interfere with a user's screen touch operation, the optical device 120 having a flat-plate structure does not obstruct the screen touch operation.

The operation of the display apparatus 100 is described below with reference to FIGS. 1A and 1B.

Referring to FIG. 1A, the image controller 130 may turn on the pixels of the first region 111 of the display device 110 and input a 2D image signal to the first region 111. At this time, the image controller 130 may turn off the pixels of the second region 112. However, this is merely an example, and the disclosure is not limited thereto. Light L1 for a 2D image, generated by turning on the pixels of the first region 111, passes through the transmission unit 121 of the optical device 120 located above the first region 111 and is output diffusely in all directions without directionality, thereby displaying the 2D image.

Referring to FIG. 1B, the image controller 130 may turn on the second region 112 of the display device 110 and input a 3D image signal to the second region 112. At this time, the image controller 130 may turn off the pixels of the first region 111. However, this is merely an example, and the disclosure is not limited thereto. Light L2 for a 3D image, formed by turning on the pixels of the second region 112, may be output by passing through the separation unit 122 of the optical device 120 above the second region 112. The light L2 may be refracted by the separation unit 122 and separated into viewing zones, thereby displaying the 3D image.

Because the display apparatus 100 uses the first region 111 for displaying a 2D image and the second region 112 for displaying a 3D image, the resolution of the display device 110 may be divided in half for utilization. In some embodiments, although the resolution is reduced by half compared to when using all pixels of the display device 110, the user hardly perceives this reduction at a high resolution and may enjoy both 2D and 3D images without discomfort.

The display apparatus 100 is capable of performing low-power 2D/3D switching and simultaneously displaying 2D and 3D images on mobile devices, and may be applied to devices requiring a very small thickness and low power consumption, such as smartphones, tablets, wearable watches, virtual reality (VR) glasses, and augmented reality (AR) glasses. However, the applicable products are not limited to these, and the display apparatus 100 according to the embodiment of the disclosure may also be applied to large-area display apparatuses such as TVs and monitors.

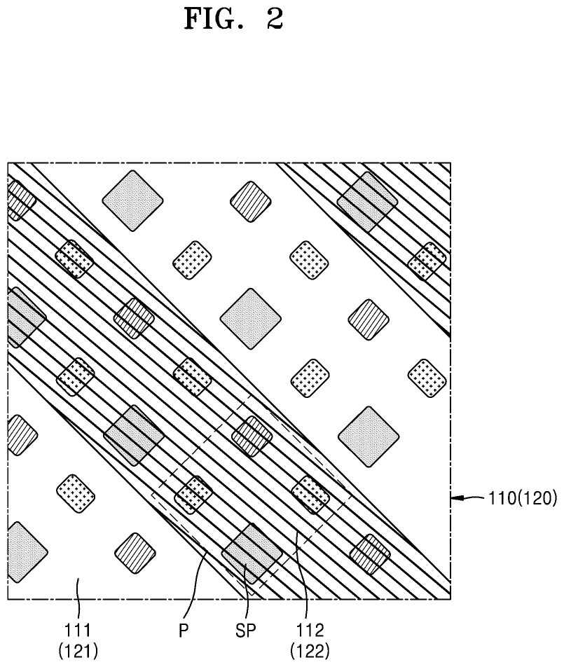

FIGS. 2, 3, and 4 illustrate various examples of an arrangement structure of the first region 111 and the second region 112 in the display apparatus 100, according to an embodiment of the disclosure.

Referring to FIG. 2, the first region 111 and the second region 112 may be arranged in a diagonal direction of the display device 110. The transmission unit 121 may be provided to overlap the first region 111, and the separation unit 122 may be provided to overlap the second region 112. In the drawings, reference numeral SP may represent a subpixel, and P may represent a pixel. The display device 110 may include pixels P having a diamond shape.

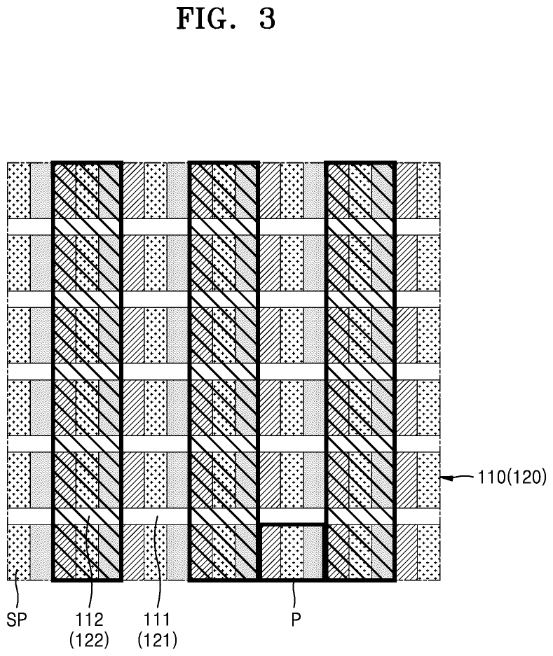

Referring to FIG. 3, the first region 111 and the second region 112 may be arranged along lines in a longitudinal or vertical direction of the display device 110. In this case, the longitudinal or vertical direction may be defined based on a user's perspective when viewing the screen. The transmission unit 121 and the separation unit 122 may be arranged vertically to respectively correspond to the first region 111 and the second region 112. When the transmission unit 121 and the separation unit 122 are arranged vertically as described above, a portrait screen mode may be applied. Alternatively, the first region 111, the second region 112, the transmission unit 121, and the separation unit 122 may be arranged in a lateral or horizontal direction of the display device 110 or the screen, so that a landscape screen mode may be applied.

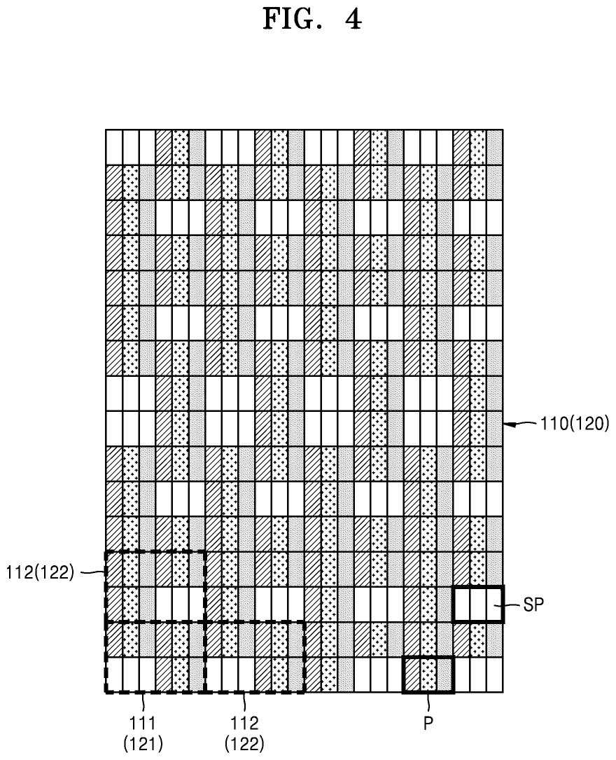

Referring to FIG. 4, the first region 111, the second region 112, the transmission unit 121, and the separation unit 122 may be partitioned at the pixel P level. For example, the first region 111 and the second region 112 may be alternately provided for each pixel P or in units of a plurality of pixels. FIG. 4 illustrates an example in which the first region 111 and the second region 112 are alternately arranged every four pixels P. In some embodiments, the first region 111 and the second region 112 may be randomly arranged. In this manner, arranging the first region 111 and the second region 112 at the pixel level may reduce the occurrence of moiré patterns.

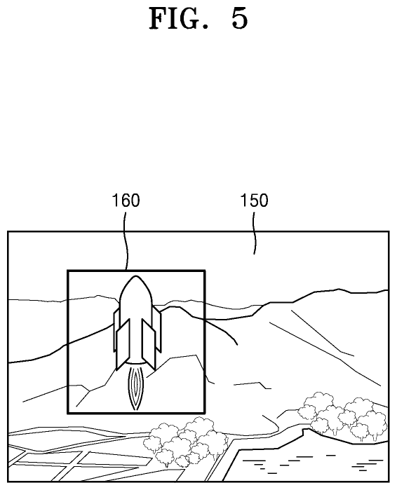

FIG. 5 illustrates an example in which both a 2D image and a 3D image are displayed together on a single screen. For example, a background image 150 may be displayed as a 2D image, while a main image 160 in a central portion may be displayed as a 3D image.

Pixels of the first region 111 located in an area corresponding to the background image 150 may be turned on, and a 2D background image signal may be input, while the remaining pixels of the first region 111 may be turned off. Pixels of the second region 112 located in an area corresponding to the main image 160 may be turned on and a 3D image signal may be input, while the remaining pixels of the second region 112 may be turned off. In this way, according to an embodiment of the disclosure, the display apparatus 100 may display both a 2D image and a 3D image together on a single screen.

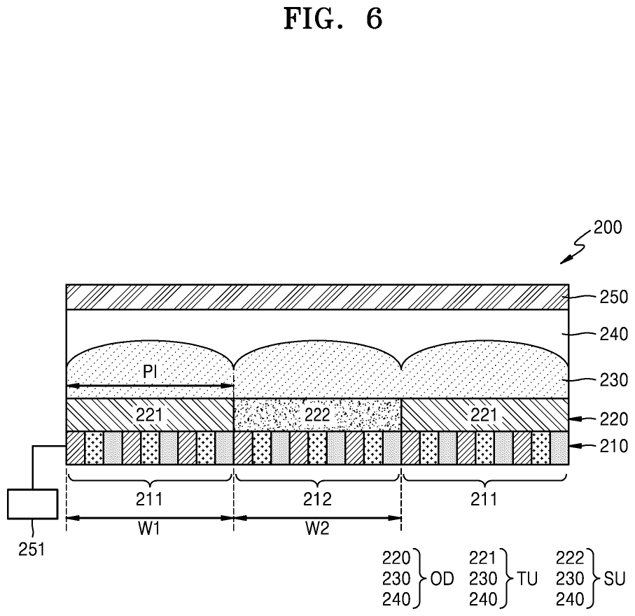

FIG. 6 schematically illustrates a display device according to an embodiment of the disclosure.

A display apparatus 200 includes a display device 210 including a first region 211 for displaying a 2D image and a second region 212 for displaying a 3D image, an image controller 251 configured to independently turn on and off the first region 211 and the second region 212, and an optical device OD including a transmission unit TU that transmits the 2D image and a separation unit SU that separates viewing zones for the 3D image. In some embodiments, the first region 211 may include a plurality of regions and the second region 212 may include a plurality of regions.

The display device 210 and the image controller 251 may be similar to the display device 110 and the image controller 130 described with reference to FIG. 1, so a detailed description thereof is omitted here.

The optical device OD may include a patterned retarder 220, a lenticular lens array 230 provided on the patterned retarder 220, and a liquid crystal lenticular lens array 240 provided on the lenticular lens array 230.

The patterned retarder 220 may include a transparent portion 221 that transmits incident light and a half-wave plate 222 that converts a polarization direction of the incident light. The transparent portion 221 may be arranged in an area corresponding to the first region 211, and the half-wave plate 222 may be arranged in an area corresponding to the second region 212. The transparent portion 221 and the half-wave plate 222 may be alternately arranged. The transparent portion 221 may transmit the incident light without changing its polarization direction, whereas the half-wave plate 222 converts a polarization direction of the incident light by delaying its phase. The half-wave plate 222 may convert P-polarized light into S-polarized light or S-polarized light into P-polarized light.

The lenticular lens array 230 may have a convex lens shape and have a structure in which lenticular lenses are arranged. A pitch PI of the lenticular lens array 230 may be equal to a width W1 of the first region 211 or a width W2 of the second region 212. In some embodiments, the width W1 of the first region 211 may be equal to the width W2 of the second region 212.

The liquid crystal lenticular lens array 240 may exhibit birefringent properties depending on a polarization direction of the incident light. The liquid crystal lenticular lens array 240 has a shape opposite to that of the lenticular lens array 230 and may be combined with the lenticular lens array 230 without the intervention of another layer. For example, the lenticular lens array 230 may have a flat surface on one side and a convex lenticular lens shape on the other side. The liquid crystal lenticular lens array 240 may have a flat surface on one side and a concave lenticular lens shape on the other side. The lenticular lens array 230 and the liquid crystal lenticular lens array 240 may be combined by joining the convex portion with the concave portion. In FIG. 6, the flat surface of the lenticular lens array 230 may be positioned at the bottom, and the flat surface of the liquid crystal lenticular lens array 240 may be positioned at the top. Thus, when the lenticular lens array 230 and the liquid crystal lenticular lens array 240 may be combined together to form an overall flat plate structure. A flat sheet 250 may be provided on an upper surface of the liquid crystal lenticular lens array 240. The flat sheet 250 may serve as a protective sheet for the liquid crystal lenticular lens array 240.

The transmission unit TU of the optical device OD may include the transparent portion 221, the lenticular lens array 230, and the liquid crystal lenticular lens array 240. The separation unit SU of the optical device OD may include the half-wave plate 222, the lenticular lens array 230, and the liquid crystal lenticular lens array 240.

An operation of the display apparatus 200 is described below.

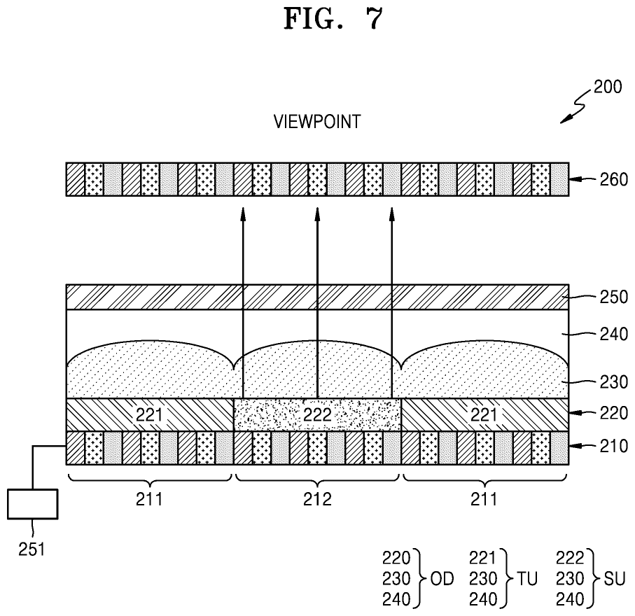

Referring to FIG. 7, the first region 211 of the display device 210 may be turned on, and the second region 212 may be turned off. The display device 210 may emit light of a first polarization, for example, P-polarization. The pixels in the first region 211 may be driven, and light of P-polarization may be emitted from the first region 211. The light of P-polarization may pass through the transparent portion 221 and the lenticular lens array 230, which are arranged to correspond to the first region 211. The lenticular lens array 230 may have a first refractive index n1. The liquid crystal lenticular lens array 240 may exhibit birefringent properties that results in a slow-axis refractive index and a fast-axis refractive index. The liquid crystal lenticular lens array 240 may have a first refractive index n1 or a second refractive index n2 depending on the polarization of the incident light. For example, the slow-axis refractive index of the liquid crystal lenticular lens array 240 may be the first refractive index n1, and the fast-axis refractive index may be the second refractive index n2, and the relationship may be n1>n2. The liquid crystal lenticular lens array 240 may have the first refractive index n1 for light of P-polarization and the second refractive index n2 for light of S-polarization.

When light of P-polarization passes through the lenticular lens array 230 and enters the liquid crystal lenticular lens array 240, the liquid crystal lenticular lens array 240 may function as a material having a first refractive index n1 for the light of P-polarization. Because the lenticular lens array 230 has a first refractive index n1 and the liquid crystal lenticular lens array 240 has a first refractive index n1 for the light of P-polarization, the light of P-polarization passing through the lenticular lens array 230 and the liquid crystal lenticular lens array 240 is equivalent to passing through a flat layer without any change in refractive index. Therefore, the light of P-polarization may pass through the liquid crystal lenticular lens array 240 and be output without refraction along the path. In this manner, a 2D image 260 may be displayed.

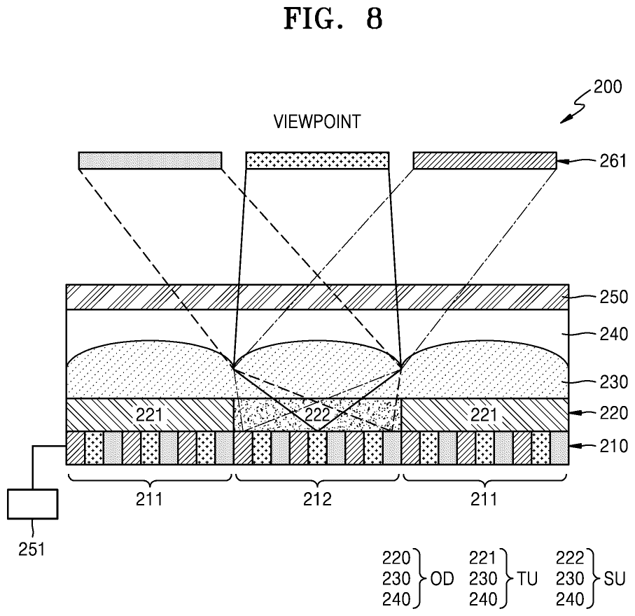

Referring to FIG. 8, the first region 211 of the display device 210 may be turned off, and the second region 212 may be turned on. The pixels in the second region 212 may be driven, and light of P-polarization may be emitted from the second region 212. The P-polarized light may be converted into S-polarized light as it passes through the half-wave plate 222, and the S-polarized light may then pass through the lenticular lens array 230 and be incident on the liquid crystal lenticular lens array 240. When the S-polarized light passes through the liquid crystal lenticular lens array 240, the liquid crystal lenticular lens array 240 may have a second refractive index n2 for the S-polarized light. Therefore, an optical path of the S-polarized light may be refracted while passing from the lenticular lens array 230 having a first refractive index n1 to the liquid crystal lenticular lens array 240 having a second refractive index n2, so that viewing zones may be separated. In this manner, a 3D image 261 may be displayed.

The first region 211 and the second region 212 may be partitioned in units of pixels, in units of horizontal lines, or in units of vertical lines. As described above, the transmission unit TU of the display apparatus 200 includes the transparent portion 221, the lenticular lens array 230, and the liquid crystal lenticular lens array 240, which are located in an area corresponding to the first region 211, so that light passing through the transparent unit TU may display a 2D image. Furthermore, the separation unit SU includes the half-wave plate 222, the lenticular lens array 230, and the liquid crystal lenticular lens array 240, which are located in an area corresponding to the second region 212, so that light passing through the separation section SU may display a 3D image.

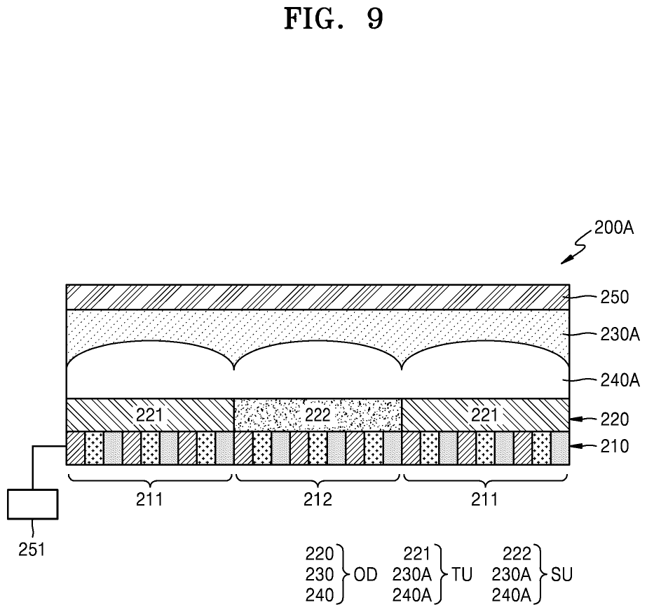

FIG. 9 illustrates an example in which positions of a lenticular lens array and a liquid crystal lenticular lens array are switched compared with the display apparatus 200 of FIG. 6. The differences FIG. 6 and FIG. 9 are described below.

A display apparatus 200A includes a display device 210 and an optical device OD. The optical device OD may include a patterned retarder 220, a liquid crystal lenticular lens array 240A provided on the patterned retarder 220, and a lenticular lens array 230A provided on the liquid crystal lenticular lens array 240A. The liquid crystal lenticular lens array 240A includes a convex lenticular lens structure, and the lenticular lens array 230A may include a concave lenticular lens structure. A convex portion of the liquid crystal lenticular lens array 240A may be combined with a concave portion of the lenticular lens array 230A, and when the liquid crystal lenticular lens array 240A and the lenticular lens array 230A are combined, the overall structure may have a flat plate structure.

The transmission unit TU of the optical device OD may include the transparent portion 221, the liquid crystal lenticular lens array 240A, and the lenticular lens array 230A. The separation unit SU of the optical device OD may include the half-wave plate 222, the liquid crystal lenticular lens array 240A, and the lenticular lens array 230A.

P-polarized light emitted from the first region 211 passes through the transparent portion 221 and enters the liquid crystal lenticular lens array 240A, and because the liquid crystal lenticular lens array 240A has a first refractive index n1 for the P-polarized light, the P-polarized light may then pass through the lenticular lens array 230A having the first refractive index n1 without refraction, thereby enabling display of a 2D image.

P-polarized light emitted from the second region 212 is converted into S-polarized light by the half-wave plate 222 and enters the liquid crystal lenticular lens array 240A, and because the liquid crystal lenticular lens array 240A has a second refractive index n2 for the S-polarized light, the S-polarized light may be refracted through the lenticular lens array 230Ahaving the first refractive index n1, thereby enabling display of a 3D image.

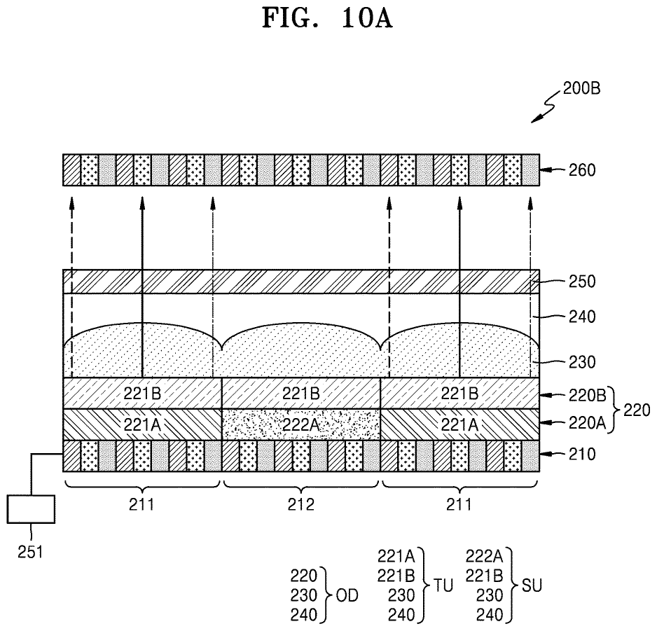

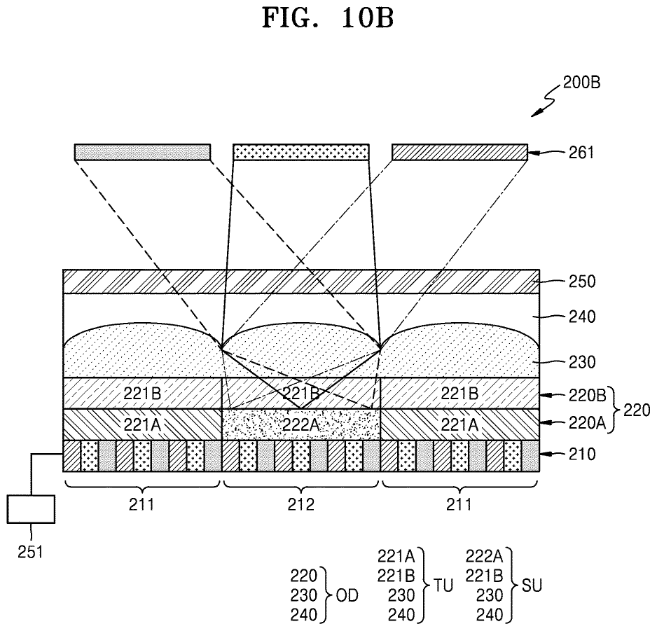

FIGS. 10A and 10B illustrate examples of a patterned retarder 220 modified differently from that shown in FIG. 6.

Components in FIGS. 10A and 10B that share the same reference numerals as those in FIG. 6 have similar functions and configurations, and therefore, detailed descriptions thereof are omitted here.

Referring to FIG. 10A, a display apparatus 200B may include two patterned retarders. The patterned retarder 220 may include a first patterned retarder 220A and a second patterned retarder 220B provided on the first patterned retarder 220A.

The first patterned retarder 220A may include a first quarter-wave plate 221A provided at a position corresponding to the first region 211, and a second negative quarter-wave plate 222A provided at a position corresponding to the second region 212. The second patterned retarder 220B may include quarter-wave plates 221B at positions corresponding to both the first region 211 and the second region 212.

FIG. 10A illustrates an operation of displaying the 2D image 260.

To display the 2D image 260, the first region 211 may be turned on, and the second region 212 may be turned off. The display device 210 may emit light of a first polarization, for example, P-polarization. When the first region 211 is turned on, the light of P-polarization (or P-polarized light) emitted from the first region 211 is incident on the first quarter-wave plate 221A corresponding to the first region 211, and the P-polarized light may be converted into left-circularly polarized light by the first quarter-wave plate 221A. The left-circularly polarized light may be incident onto the second patterned retarder 220B, and then may be converted into P-polarized light because the second patterned retarder 220B is formed of the quarter-wave plate 221B. When the P-polarized light passes through the lenticular lens array 230 and is incident on the liquid crystal lenticular lens array 240, the liquid crystal lenticular lens array 240 functions as a material having a first refractive index n1 for the P-polarized light, so the P-polarized light may pass through the liquid crystal lenticular lens array 240 and be output without refraction along the path. In this manner, the 2D image 260 may be displayed.

FIG. 10B illustrates an operation of displaying the 3D image 261.

To display the 3D image 261, the first region 211 may be turned off, and the second region 212 may be turned on. The display device 210 may emit light of a first polarization, for example, P-polarization. When the second region 212 is turned on, the light of P-polarization (or P-polarized light) emitted from the second region 212 is incident on the second negative quarter-wave plate 222A corresponding to the second region 212, and the P-polarized light may be converted into right-circularly polarized light by the second negative quarter-wave plate 222A. The right-circularly polarized light may be incident on the second patterned retarder 220B, and then may be converted into S-polarized light because the second patterned retarder 220B is formed of the quarter-wave plate 221B. When the S-polarized light passes through the lenticular lens array 230 and is incident on the liquid crystal lenticular lens array 240, the liquid crystal lenticular lens array 240 functions as a material having a second refractive index n2 for the S-polarized light, so the S-polarized light may be refracted through the liquid crystal lenticular lens array 240 and output. In this manner, the 3D image 261 may be displayed.

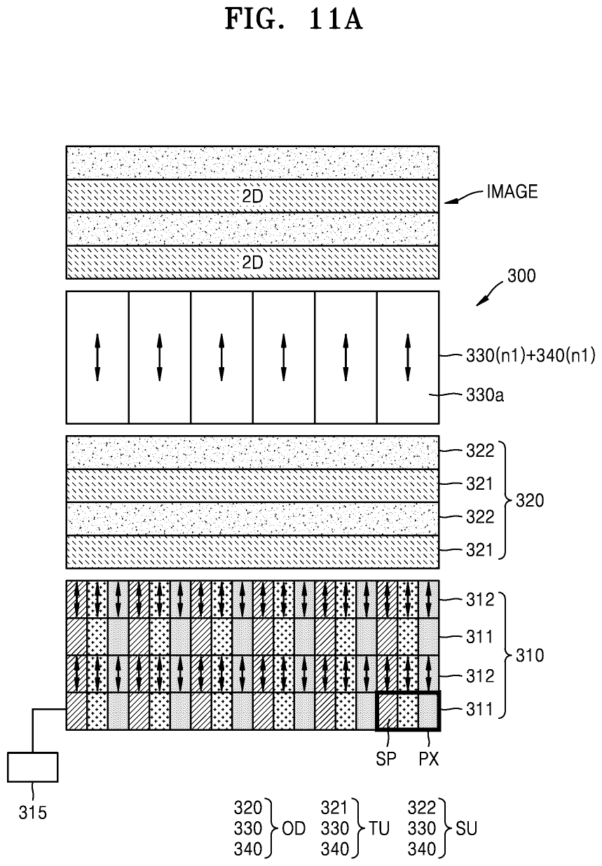

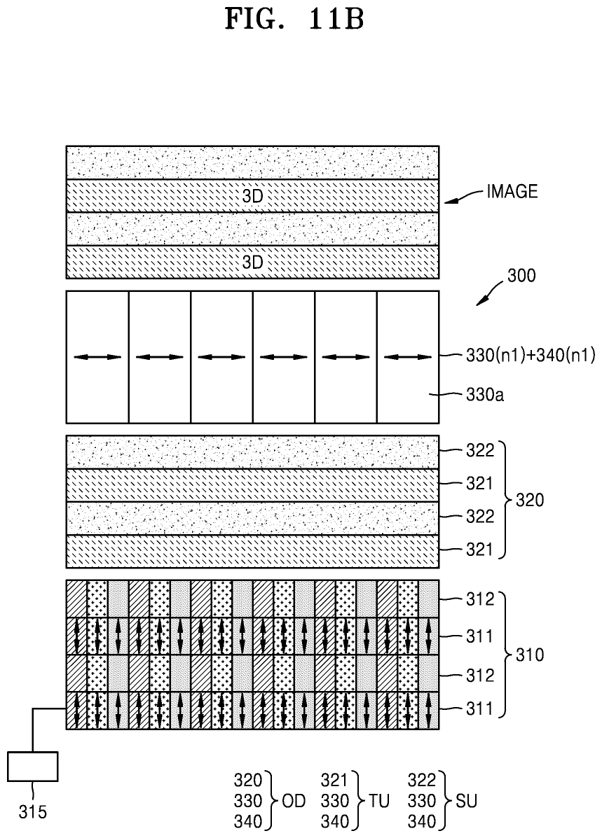

FIGS. 11A and 11B illustrate a display apparatus 300 according to an embodiment of the disclosure.

The display apparatus 300 may include a display device 310, a patterned retarder 320, a lenticular lens array 330, and a liquid crystal lenticular lens array 340. In FIGS. 11A and 11B, each component is illustrated in a plan view for convenience of description. In addition, because the lenticular lens array 330 and the liquid crystal lenticular lens array 340 operate as one set, they are illustrated in a single plan view.

The display device 310 may include a first region 311 and a second region 312. The display device 310 may have a structure in which a plurality of pixels PX are arranged in a matrix form. SP denotes a subpixel. In this structure, the first region 311 may include odd-numbered lines, and the second region 312 may include even-numbered lines. Here, a line may represent a horizontal line. An image controller 315 may turn on and off the first region 311 and the second region 312 of the display device 310 and input image signals respectively corresponding thereto.

The patterned retarder 320 may include a transparent portion 321 provided on odd-numbered lines corresponding to the first region 311, and a half-wave plate 322 provided on even-numbered lines corresponding to the second region 312. In the display apparatus 300, an optical device OD may include the patterned retarder 320, the lenticular lens array 330, and the liquid crystal lenticular lens array 340. A transmission unit TU of the optical device OD may include the transparent portion 321, the lenticular lens array 330, and the liquid crystal lenticular lens array 340. A separation unit SU of the optical device OD may include the half-wave plate 322, the lenticular lens array 330, and the liquid crystal lenticular lens array 340.

The lenticular lens array 330 may include lenticular lenses 330a arranged in a direction perpendicular to the odd-numbered lines of the first region 311 and the even-numbered lines of the second region 312. The liquid crystal lenticular lens array 340 may be arranged to mate with the lenticular lens array 330. The lenticular lens array 330 has a first refractive index n1, and the liquid crystal lenticular lens array 340 may have the first refractive index n1 or a second refractive index n2 depending on a polarization direction of incident light. For example, the liquid crystal lenticular lens array 340 may have the first refractive index n1 for P-polarized light and the second refractive index n2 for S-polarized light.

FIG. 11A may illustrate an operation state in which the display apparatus 300 displays a 2D image. Referring to FIG. 11A, pixels in the first region 311 of the display device 310 may be turned on, while pixels in the second region 312 may be turned off. The display device 310 may emit light of a first polarization, for example, P-polarization. The light of P-polarization may pass through the transparent portion 321 corresponding to the first region 311 without a change in the polarization direction. When the light of P-polarization passes through the lenticular lens array 330 and is incident on the liquid crystal lenticular lens array 340, the liquid crystal lenticular lens array 340 may have the first refractive index n1 for the light of P-polarization. Therefore, the P-polarized light may pass through the liquid crystal lenticular lens array 340 without refraction and be output, thereby enabling the display of a 2D image.

FIG. 11B may illustrate an operation state in which the display apparatus 300 displays a 3D image. Referring to FIG. 11B, pixels in the first region 311 of the display device 310 may be turned off, while pixels in the second region 312 may be turned on. The display device 310 may emit light of a first polarization, for example, P-polarization. The P-polarized light may be converted into S-polarized light when passing through the half-wave plate 322 corresponding to the second region 312. When the S-polarized light passes through the lenticular lens array 330 and is incident on the liquid crystal lenticular lens array 340, the liquid crystal lenticular lens array 340 may have the second refractive index n2 for S-polarization. Therefore, the S-polarized light is refracted and output from the liquid crystal lenticular lens array 340, thereby separating the viewing zones and enabling the display of a 3D image.

FIGS. 11A and 11B illustrate an example in which the first region 311 and the second region 312 are partitioned into lines, but a method of partitioning the first region 311 and the second region 312 may be implemented in various ways. The display apparatus 300 may have a resolution that is halved because of using half of the pixels for 2D images and the other half for 3D images, but is able to operate passively without electrical driving of the optical device OD to an extent that this reduction is not perceived by the user. Thereby enabling low-power display of both 2D and 3D images. The display apparatus 300 allows for screen touch without electrical shielding and may reduce electrical noise caused by a coupling phenomenon resulting from pulses according to voltage application. Like in the display apparatus 300, when different retarders are applied to each horizontal line, odd-numbered lines may display a 2D image and even-numbered lines may display a 3D image. Additionally, content requiring high-resolution representation may be displayed as a 2D image, while objects requiring a sense of depth may be represented as a 3D image. Moreover, while FIGS. 11A and 11B show the first region 311 and the second region 312 partitioned into horizontal lines, the first region 311 and the second region 312 may be partitioned into vertical columns.

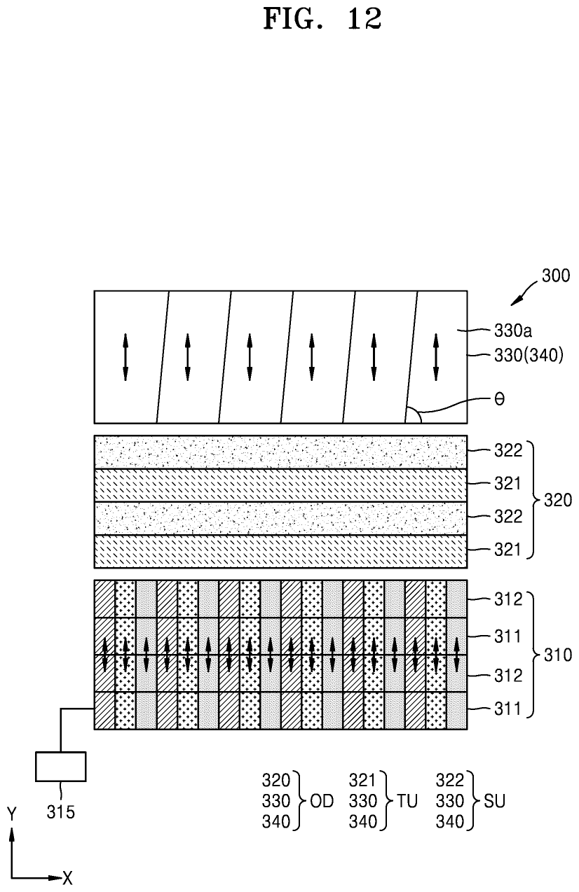

FIG. 12 illustrates a structure in which lenticular lenses 330a of the lenticular lens array 330 and the liquid crystal lenticular lens array 340 are arranged obliquely, as compared to FIGS. 11A and 11B. The lenticular lens array 330 may be arranged such that the lenticular lenses 330a are titled at an angle θ relative to a horizontal direction (an X-direction) of the display device 310. The lenticular lenses 330a each have a semi-cylindrical shape, and may be arranged such that a height direction of each semi-cylinder may be tilted at an angle θ relative to the horizontal direction (X-direction) of the display device 310. The horizontal direction (X-direction) may represent a horizontal direction relative to the user. The angle θ may be less than 90° relative to the horizontal direction (X-direction). By arranging the lenticular lens array 230 and the liquid crystal lenticular lens array 240 in a tilted manner, moiré patterns may be reduced.

According to an embodiment of the disclosure, the display apparatus 100, 200, 200A, 200B, or 300 is of a passive type and may selectively display a 2D image and a 3D image. According to an embodiment of the disclosure, the display apparatus 100, 200, 200A, 200B, or 300 may be applied to various electronic apparatuses such as TVs, computer monitors, and mobile devices, thereby enabling users to view both 2D and 3D images.

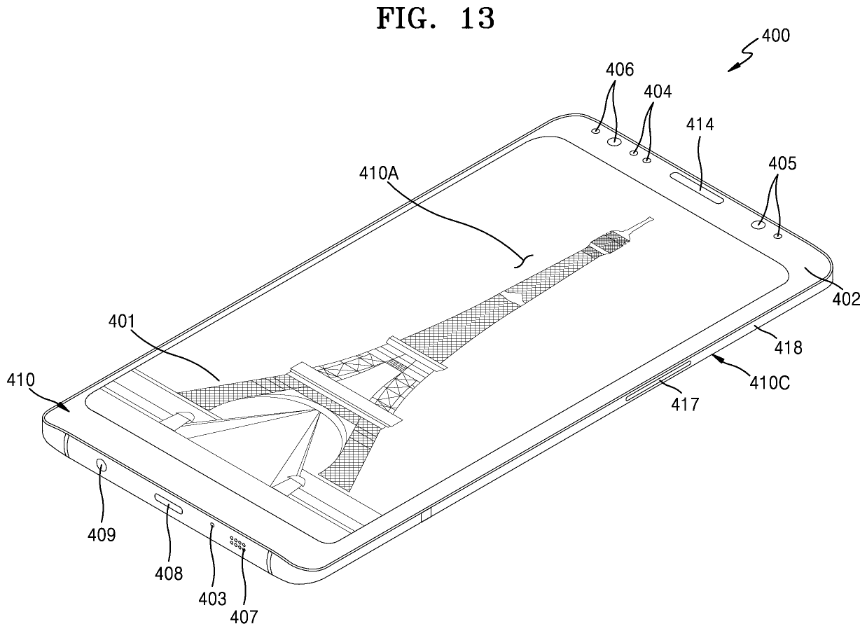

FIG. 13 illustrates an example in which the display apparatus 100, 200, 200A, 200B, or 300 is applied to a mobile phone, according to an embodiment of the disclosure.

FIG. 13 illustrates an example of the electronic apparatus 400 applied to a mobile phone, but the disclosure is not limited thereto. FIG. 13 shows a front surface of the electronic apparatus 400.

According to an embodiment of the disclosure, the electronic apparatus 400 may include a housing 410 including a front surface 410A and a side surface 410C. According to an embodiment of the disclosure, the front surface 410A may be formed by a front plate 402 (e.g., a glass plate including various coating layers, or polymer plate) of which at least a portion is substantially transparent. In an embodiment of the disclosure, the front plate 402 may be coupled to the housing 410 to form an internal space together with the housing 410. In various embodiments of the disclosure, the ‘internal space’ may refer to an internal space of the housing 410 that accommodates at least a portion of a display apparatus 401.

The side surface 410C may be combined with the front plate 402, and may be formed by a side bezel structure 418 including metal and/or polymer.

According to an embodiment of the disclosure, the electronic apparatus 400 may include at least one of the display apparatus 401, audio modules 403, 407, and 414, a sensor module 404, a camera module 405, a key input device 417, a light-emitting element 406, or connector holes 408 and 409. In various embodiments of the disclosure, the electronic apparatus 400 may not include at least one (e.g., the key input device 417 or the light-emitting element 406) of the above-described components, or may further include other components.

As the display apparatus 401, any of the display apparatuses 100, 200, 200A, 200B, and 300 described with reference to FIGS. 1 to 12 may be applied.

The audio modules 403, 407, and 414 may include a microphone hole 403 and speaker holes 407 and 414. A microphone for obtaining external sounds may be located in the microphone hole 403, and in various embodiments of the disclosure, a plurality of microphones may be arranged to detect the direction of sound. The speaker holes 407 and 414 may include an external speaker hole 407 and a call receiver hole 414. In various embodiments of the disclosure, the speaker holes 407 and 414 and the microphone hole 403 may be implemented as a single hole, or a speaker may be included therein without the speaker holes 407 and 414 (e.g., a piezo speaker).

The sensor module 404 may generate an electrical signal or a data value corresponding to an internal operation state of the electronic apparatus 400 or an external environmental state. The sensor module 404 may include, for example, a first sensor module (e.g., a proximity sensor) and/or a second sensor module (e.g., a fingerprint sensor) disposed on the front surface 410A of the housing 410. The electronic apparatus 400 may further include other sensor modules not illustrated in FIG. 13, such as at least one of a gesture sensor, a gyro sensor, a barometric pressure sensor, a magnetic sensor, an acceleration sensor, a grip sensor, a color sensor, an infrared (IR) sensor, a biometric sensor, a temperature sensor, a humidity sensor, or an illuminance sensor.

The electronic apparatus 400 shown in FIG. 13 is an example and does not limit the form of devices to which technical concepts set forth herein may be applied. The technical concepts set forth herein may be applied to, for example, foldable electronic apparatuses, tablets, or laptops capable of folding horizontally or vertically by employing flexible displays and hinge structures.

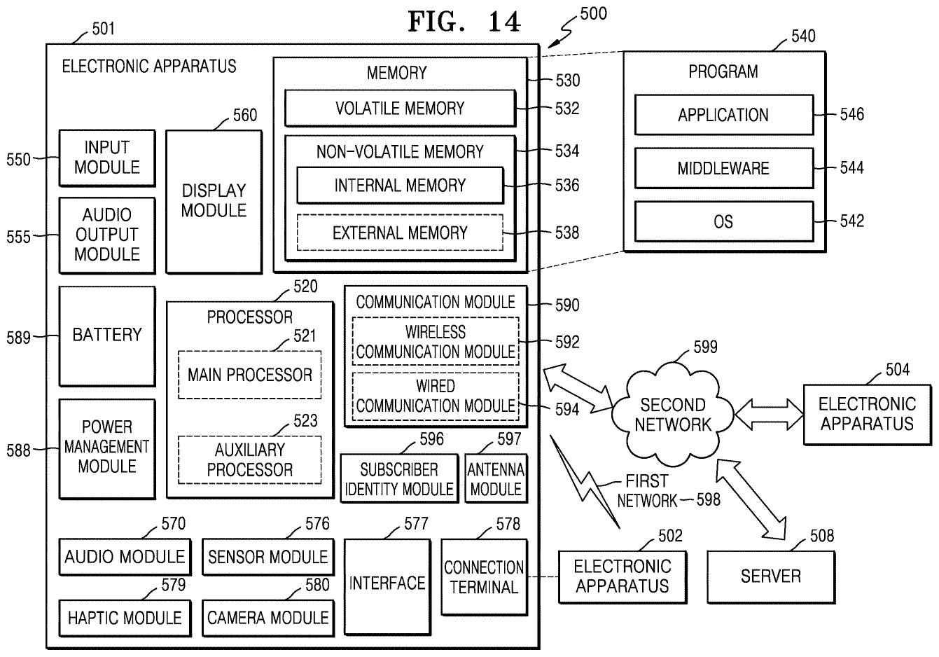

FIG. 14 is a block diagram of an electronic apparatus 501 within a network environment 500, according to various embodiments of the disclosure. Referring to FIG. 14, in the network environment 500, the electronic apparatus 501 may communicate with an electronic apparatus 502 over a first network 598 (e.g., a short-range wireless communication network), or communicate with at least one of an electronic apparatus 504 or a server 508 over a second network 599 (e.g., a long-range wireless communication network). According to an embodiment of the disclosure, the electronic apparatus 501 may communicate with the electronic apparatus 504 via the server 508. According to an embodiment of the disclosure, the electronic apparatus 501 may include a processor 520, memory 530, an input module 550, a sound output module 555, a display module 560, an audio module 570, a sensor module 576, an interface 577, a connection terminal 578, a haptic module 579, a camera module 580, a power management module 588, a battery 589, a communication module 590, a subscriber identification module 596, or an antenna module 597. In an embodiment of the disclosure, the electronic apparatus 501 may not include at least one of these components (e.g., the connection terminal 578) or further include one or more other components. In an embodiment of the disclosure, some of these components (e.g., the sensor module 576, the camera module 580, or the antenna module 597) may be integrated into a single component (e.g., the display module 560).

For example, the processor 520 may execute software (e.g., a program 540) to control at least one other component (e.g., a hardware or software component) of the electronic apparatus 501, which is connected to the processor 520, and perform various data processing or computations. According to an embodiment of the disclosure, as at least a part of the data processing or computations, the processor 520 may store commands or data received from other components (e.g., the sensor module 576 or the communication module 590) in a volatile memory 532, process the commands or data stored in the volatile memory 532, and store the resulting data in a non-volatile memory 534. According to an embodiment of the disclosure, the processor 520 may include a main processor 521 (e.g., a CPU or an AP), or an auxiliary processor 523 (e.g., a GPU, an NPU, an image signal processor, a sensor hub processor, or a CP) which is operable independently of or in conjunction with the main processor 521. For example, when the electronic apparatus 501 includes the main processor 521 and the auxiliary processor 523, the auxiliary processor 523 may be configured to use lower power than the main processor 521 or to be specialized for a specified function. The auxiliary processor 523 may be implemented separately from or as a part of the main processor 521.

For example, the auxiliary processor 523 may control at least some of functions or states related to at least one of the components of the electronic apparatus 501 (e.g., the display module 560, the sensor module 576, or the communication module 590) instead of the main processor 521 while the main processor 521 is in an inactive (e.g., sleep) state, or in conjunction with the main processor 521 while the main processor 521 is in an active state (e.g., executing an application). According to an embodiment of the disclosure, the auxiliary processor 523 (e.g., the image signal processor or CP) may be implemented as a part of another functionally related component (e.g., the camera module 580 or communication module 590). According to an embodiment of the disclosure, the auxiliary processor 523 (e.g., the NPU) may include a hardware structure specialized for processing an AI model. AI models may be generated through machine learning. Such machine learning may be performed by the electronic apparatus 501 itself, or through a separate server (e.g., the server 508). Learning algorithms may include, for example, supervised learning, unsupervised learning, semi-supervised learning, or reinforcement learning, but are not limited to the stated examples. An AI model may include a plurality of artificial neural network layers. An artificial neural network may be, but is not limited to, one of a deep neural network (DNN), a convolutional neural network (CNN), a recurrent neural network (RNN), a restricted Boltzmann machine (RBM), a deep belief network (DBN), a bidirectional recurrent DNN (BRDNN), a deep Q-network (DQN), or a combination of two or more of the stated networks. The AI model may include a software structure in addition to or instead of the hardware structure.

The memory 530 may store various types of data used by at least one component (e.g., the processor 520 or the sensor module 576) of the electronic apparatus 501. The various types of data may include, for example, input data or output data for software (e.g., the program 540) and commands related thereto. The memory 530 may include the volatile memory 532 or the non-volatile memory 534.

The program 540 may be stored in the memory 530 as software and include, for example, an operating system (OS) 542, middleware 544, or an application 546.

The input module 550 may receive commands or data to be used by components (e.g., the processor 520) of the electronic apparatus 501 from outside of the electronic apparatus 501 (e.g., a user). The input module 550 may include, for example, a microphone, a mouse, a keyboard, a key (e.g., a button), or a digital pen (e.g., a stylus pen).

The sound output module 555 may output sound signals to the outside of the electronic apparatus 501. The sound output module 555 may include, for example, a speaker or a receiver. The speaker may be used for general purposes, such as playing multimedia or playing recordings. The receiver may be used to receive incoming calls. According to an embodiment of the disclosure, the receiver may be implemented separately from or as a part of the speaker.

The display module 560 may visually provide information to the outside of the electronic apparatus 501 (e.g., the user). The display module 560 may include, for example, a display, a holographic device, or a projector, as well as control circuitry for controlling a corresponding device. According to an embodiment of the disclosure, the display module 560 may include a touch sensor configured to detect a touch, or a pressure sensor configured to measure the intensity of a force generated by the touch. The display module 560 may include the display apparatuses 100, 200, 200A, 200B, and 300 described with reference to FIGS. 1 to 12.

The audio module 570 may convert sound into an electrical signal, or vice versa. According to an embodiment of the disclosure, the audio module 570 may obtain sound via the input module 550, or output the sound via the sound output module 555 or an external electronic apparatus (e.g., the electronic apparatus 502) (e.g., a speaker or a headphone) that is connected directly or wirelessly to the electronic apparatus 501.

The sensor module 576 may detect an operating state (e.g., power or temperature) of the electronic apparatus 501 or an external environmental state (e.g., the user's state), and generate an electrical signal or data value corresponding to the detected state. According to an embodiment of the disclosure, the sensor module 576 may include, for example, a gesture sensor, a gyro sensor, a barometric pressure sensor, a magnetic sensor, an acceleration sensor, a grip sensor, a proximity sensor, a color sensor, an IR sensor, a biometric sensor, a temperature sensor, a humidity sensor, or an illuminance sensor.

The interface 577 may support one or more specified protocols that may be used by the electronic apparatus 501 to directly or wirelessly connect with an external electronic apparatus (e.g., the electronic apparatus 502). According to an embodiment of the disclosure, the interface 577 may include, for example, a high-definition multimedia interface (HDMI), a universal serial bus (USB) interface, a secure digital (SD) card interface, or an audio interface.

The connection terminal 578 may include a connector via which the electronic apparatus 501 may be physically connected to an external electronic apparatus (e.g., the electronic apparatus 502). According to an embodiment of the disclosure, the connection terminal 578 may include, for example, an HDMI connector, a USB connector, an SD card connector, or an audio connector (e.g., a headphone connector).

The haptic module 579 may convert electrical signals into mechanical stimuli (e.g., vibration or movement) or electrical stimuli that the user is able to perceive through tactile or kinesthetic sensation. According to an embodiment of the disclosure, the haptic module 579 may include, for example, a motor, a piezoelectric element, or an electrical stimulation device.

The camera module 580 may capture still images or videos. According to an embodiment of the disclosure, the camera module 580 may include one or more lenses, image sensors, image signal processors, or flashes.

The power management module 588 may manage power supplied to the electronic apparatus 501. According to an embodiment of the disclosure, the power management module 588 may be implemented as at least a part of, for example, a power management integrated circuit (PMIC).

The battery 589 may supply power to at least one component of the electronic apparatus 501. According to an embodiment of the disclosure, the battery 589 may include, for example, a primary cell which is non-rechargeable, a secondary cell which is rechargeable, or a fuel cell.

The communication module 590 may support establishing a direct (e.g., wired) communication channel or a wireless communication channel between the electronic apparatus 501 and an external electronic apparatus (e.g., the electronic apparatus 502, the electronic apparatus 504, or the server 508) and performing communication via the established communication channel. The communication module 590 may include one or more CPs that operate independently of the processor 520 (e.g., AP) and support direct (e.g., wired) communication or wireless communication. According to an embodiment of the disclosure, the communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic apparatus 504 over the first network 598 (e.g., a short-range communication network, such as Bluetooth, Wireless Fidelity (Wi-Fi) Direct (WFD), or Infrared Data Association (IrDA)) or the second network 599 (e.g., a long-range communication network, such as a legacy cellular network, a 5th generation (5G) network, a next-generation communication network, the Internet, or a computer network (e.g., a LAN or wide area network (WAN)). These various types of communication modules may be integrated into a single component (e.g., a single chip) or be implemented as a plurality of separate components (e.g., a plurality of chips). The wireless communication module 592 may identify or authenticate the electronic apparatus 501 within a communication network such as the first network 598 or the second network 599 by using subscriber information (e.g., an international mobile subscriber identity (IMSI)) stored in the subscriber identification module 596.

The wireless communication module 592 may support 5G networks and next-generation communication technologies following 4th generation (4G) networks, such as new radio (NR) access technology. The NR access technology may support high-speed transfer of large volume of data (enhanced mobile broadband (eMBB)), minimization of power consumption for a terminal and massive access by a large number of terminals (massive machine type communications (mMTC)), or high reliability and low latency (ultra-reliable and low latency communications (URLLC)). For example, the wireless communication module 592 may support high frequency bands (e.g., millimeter-wave (mmWave) bands) to achieve a high data rate. The wireless communication module 592 may support various technologies for securing performance in high frequency bands, such as beamforming, massive multiple-input and multiple-output (MIMO), full dimensional MIMO (FD-MIMO), array antennas, analog beam-forming, or large-scale antennas. The wireless communication module 592 may support various requirements dictated for the electronic apparatus 501, an external electronic apparatus (e.g., the electronic apparatus 504), or a network system (e.g., the second network 599). According to an embodiment of the disclosure, the wireless communication module 592 may support a peak data rate (e.g., 20 gigabits per second (Gbps) or more) for realizing eMBB, a loss coverage (e.g., up to 164 decibels (dB) for realizing mMTC, or user plane (U-plane) latency for realizing URLLC (e.g., downlink (DL) and uplink (UL) latency of 0.5 ms or less or round trip latency of 1 ms or less).

The antenna module 597 may transmit or receive signals or power to or from the outside (e.g., an external electronic apparatus). According to an embodiment of the disclosure, the antenna module 597 may include an antenna including a radiating element composed of a conductive material or a conductive pattern formed on a substrate (e.g., a printed circuit board (PCB)). According to an embodiment of the disclosure, the antenna module 597 may include a plurality of antennas (e.g., an array antenna). In this case, at least one antenna suitable for a communication method used in the communication network, such as the first network 598 or the second network 599, may be selected by, for example, the communication module 590 from among the plurality of antennas. A signal or power may be transmitted or received between the communication module 590 and an external electronic apparatus via the selected at least one antenna. According to an embodiment of the disclosure, a component (e.g., a radio frequency integrated circuit (RFIC)) other than the radiating element may be additionally formed as a part of the antenna module 597.

According to various embodiments of the disclosure, the antenna module 597 may form an mmWave antenna module. According to an embodiment of the disclosure, the mmWave antenna module may include a PCB, an RFIC disposed on or adjacent to a first surface (e.g., a bottom surface) of the PCB and capable of supporting a specified high frequency band (e.g., an mmWave band), and a plurality of antennas (e.g., array antenna) disposed on or adjacent to a second surface (e.g., a top surface or a side) of the PCB and capable of transmitting or receiving signals in the specified high frequency band.

At least some of the components may be connected to each other and exchange signals (e.g., commands or data) with each other by using a communication scheme between peripheral devices (e.g. via a bus, General-Purpose Input and Output (GPIO), Serial Peripheral Interface (SPI), or Mobile Industry Processor Interface (MIPI)).

According to an embodiment of the disclosure, commands or data may be transmitted or received between the electronic apparatus 501 and the external electronic apparatus 504 via the server 508 connected to the second network 599. Each of the external electronic apparatuses 502 and 504 may be a device of the same type as or a different type from the electronic apparatus 501. According to an embodiment of the disclosure, all or some of operations performed by the electronic apparatus 501 may be performed by one or more of the external electronic apparatuses 502, 504, and 508. For example, when the electronic apparatus 501 needs to perform a certain function or service automatically or in response to a request from a user or another device, the electronic apparatus 501 may request the one or more external electronic apparatuses to perform at least a part of the function or service instead of or in addition to performing the function or service on its own. The one or more external electronic apparatuses receiving the request may perform at least a part of the requested function or service, or an additional function or service related to the request, and transmit a result of the performing to the electronic apparatus 501. The electronic apparatus 501 may provide the result as at least part of a response to the request with or without further processing of the result. To this end, for example, cloud computing, distributed computing, mobile edge computing (MEC), or client-server computing technology may be used. The electronic apparatus 501 may provide services by using, for example, distributed computing or mobile edge computing. In an embodiment of the disclosure, the external electronic apparatus 504 may include an Internet of things (IoT) device. The server 508 may be an intelligent server using machine learning and/or neural networks. According to an embodiment of the disclosure, the external electronic apparatus 504 or the server 508 may be included in the second network 599. The electronic apparatus 501 may be applied to intelligent services (e.g., smart homes, smart cities, smart cars, or health care) based on 5G communication technology and IoT-related technology.

A display apparatus according to an embodiment of the disclosure includes a display device including a first region 111, 211, or 311 displaying a 2D image and a second region 112, 212, or 312 displaying a 3D image, an image controller 130, 251, or 315 configured to independently turn on and off the first region 111, 211, or 311 and the second region 112, 212, or 312, and an optical device OD or 120 including a transmission unit TU or 121 configured to transmit the 2D image and a separation unit SU or 122 configured to separate viewing zones for the 3D image, wherein the transmission unit TU or 121 and the separation unit SU or 122 are configured as passive type components, wherein the first region 111, 211, or 311 and the second region 112, 212, or 312 are arranged so as not to overlap, the transmission unit TU or 121 is arranged to face the first region 111, 211, or 311, and the separation unit SU or 122 is arranged to face the second region 112, 212, or 312.

The separation unit SU or 122 of the optical device OD may include a GRIN lens, a holographic optical element, or a microlens array.

The optical device OD may include a patterned retarder 220 or 320, a lenticular lens array 230 or 330 provided on the patterned retarder 220 or 320, and a liquid crystal lenticular lens array 240 or 340 provided on the lenticular lens array 230 or 330.

The optical device OD may include a patterned retarder 220, a liquid crystal lenticular lens array 240A provided on the patterned retarder 220, and a lenticular lens array 230A provided on the liquid crystal lenticular lens array 240A.

The patterned retarder 220 may include a transparent portion 221 arranged to correspond to the first region and a half-wave plate 222 provided to correspond to the second region.

The patterned retarder may include a plurality of odd-numbered lines and a plurality of even-numbered lines, wherein the transparent portion may be provided on the plurality of odd-numbered lines, and the half-wave plate may be provided on the plurality of even-numbered lines.

The patterned retarder 220 may include a first patterned retarder 220A and a second patterned retarder 220B provided on the first patterned retarder 220A.

The first patterned retarder 220A may include a first quarter-wave plate 221A arranged to correspond to the first region, and a second negative quarter-wave plate 222A arranged to correspond to the second region.

The second patterned retarder 220B may include quarter-wave plates 221B arranged to correspond to the first region and the second region.

The lenticular lens array may have a first refractive index, and the liquid crystal lenticular lens array may have the first refractive index or a second refractive index depending on a polarization state of incident light.

The lenticular lens array may include a plurality of lenticular lenses, and the plurality of lenticular lenses may be arranged to be tilted at an angle greater than 0° and less than 90° with respect to a horizontal direction.

The lenticular lens array may have a convex lens shape facing upward or a concave lens shape facing downward.

The liquid crystal lenticular lens array has a shape opposite to that of the lenticular lens array and may be combined with the lenticular lens array without intervention of another layer.

The first region and the second region may be arranged randomly.

An electronic apparatus according to an embodiment of the disclosure includes a display apparatus 401, audio modules 403, 407, and 414, a sensor module 404, and a camera module 405, and the display apparatus 401 includes a display device including a first region 111, 211, or 311 displaying a 2D image and a second region 112, 212, or 312 displaying a 3D image, an image controller 130, 251, or 315 configured to independently turn on and off the first region 111, 211, or 311 and the second region 112, 212, or 312, and an optical device OD or 120 including a transmission unit TU or 121 configured to transmit the 2D image and a separation unit SU or 122 configured to separate viewing zones for the 3D image, wherein the transmission unit TU or 121 and the separation unit SU or 122 are configured as passive type components, wherein the first region 111, 211, or 311 and the second region 112, 212, or 312 are arranged so as not to overlap, the transmission unit TU or 121 is arranged to face the first region 111, 211, or 311, and the separation unit SU or 122 is arranged to face the second region 112, 212, or 312.

A 2D and 3D display apparatus according to an embodiment of the disclosure are capable of displaying a 2D image and a 3D image by implementing an optical device that switches between 2D and 3D images without electrical driving. Therefore, power consumption of the display apparatus may be reduced, and the user may enjoy 2D and 3D images in a simple manner.

The above embodiments of the disclosure are merely examples, and it will be understood by those of ordinary skill in the art that various modifications and equivalent other embodiments are possible therefrom. Accordingly, the true scope of technical protection according to embodiments of the disclosure should be defined by the technical spirit of the disclosure as described in the following claims.

What is claimed is:

1. A two-dimensional (2D) and three-dimensional (3D) display apparatus comprising:
a display device comprising a first region configured to display a 2D image and a second region configured to display a 3D image;
an image controller configured to independently turn on and off the first region and the second region; and
an optical device comprising a transmission unit configured to transmit the 2D image and a separation unit configured to separate viewing zones for the 3D image, wherein the transmission unit and the separation unit are configured as passive type components,
wherein the first region and the second region do not overlap, and
wherein the transmission unit faces the first region, and the separation unit faces the second region.

2. The 2D and 3D display apparatus of claim 1, wherein the separation unit of the optical device comprises a gradient index lens, a holographic optical element, or a microlens array.

3. The 2D and 3D display apparatus of claim 1, wherein
the optical device comprises a patterned retarder, a lenticular lens array on the patterned retarder, and a liquid crystal lenticular lens array on the lenticular lens array, or
the optical device comprises a patterned retarder, a liquid crystal lenticular lens array on the patterned retarder, and a lenticular lens array on the liquid crystal lenticular lens array.

4. The 2D and 3D display apparatus of claim 3, wherein the patterned retarder comprises a transparent portion corresponding to the first region and a half-wave plate corresponding to the second region.

5. The 2D and 3D display apparatus of claim 4, wherein the patterned retarder comprises a plurality of odd-numbered lines and a plurality of even-numbered lines, the transparent portion is on the plurality of odd-numbered lines, and the half-wave plate is on the plurality of even-numbered lines.

6. The 2D and 3D display apparatus of claim 3, wherein
the patterned retarder comprises a first patterned retarder and a second patterned retarder on the first patterned retarder,
the first patterned retarder comprises a first quarter-wave plate corresponding to the first region, and a second negative quarter-wave plate corresponding to the second region, and
the second patterned retarder comprises quarter-wave plates corresponding to the first region and the second region.

7. The 2D and 3D display apparatus of claim 3, wherein
the lenticular lens array has a first refractive index, and
the liquid crystal lenticular lens array has the first refractive index or a second refractive index depending on a polarization state of incident light.

8. The 2D and 3D display apparatus of claim 3, wherein the lenticular lens array includes a plurality of lenticular lenses, and the plurality of lenticular lenses are tilted at an angle greater than 0° and less than 90° with respect to a horizontal direction.

9. The 2D and 3D display apparatus of claim 3, wherein the lenticular lens array has a convex lens shape facing upward or a concave lens shape facing downward.

10. The 2D and 3D display apparatus of claim 9, wherein the liquid crystal lenticular lens array has a shape opposite to that of the lenticular lens array and is combined with the lenticular lens array without intervention of another layer.

11. The 2D and 3D display apparatus of claim 1, wherein the first region and the second region are arranged randomly.

12. An electronic apparatus comprising:
a display apparatus;
a speaker;
a sensor ; and
a camera,
wherein the display apparatus comprises:
a display device comprising a first region configured to display a two-dimensional (2D) image and a second region configured to display a three-dimensional (3D) image,
an image controller configured to independently turn on and off the first region and the second region, and
an optical device comprising a transmission unit configured to transmit the 2D image and a separation unit configured to separate viewing zones for the 3D image, wherein the transmission unit and the separation unit are configured as passive type components,
the first region and the second region are arranged so as not to overlap, and
the transmission unit faces the first region, and the separation unit faces the second region.

13. The electronic apparatus of claim 12, wherein the separation unit of the optical device comprises a gradient index lens, a holographic optical element, or a microlens array.

14. The electronic apparatus of claim 12, wherein
the optical device comprises a patterned retarder, a lenticular lens array on the patterned retarder, and a liquid crystal lenticular lens array on the lenticular lens array, or
the optical device comprises a patterned retarder, a liquid crystal lenticular lens array on the patterned retarder, and a lenticular lens array on the liquid crystal lenticular lens array.

15. The electronic apparatus of claim 14, wherein the patterned retarder comprises a transparent portion corresponding to the first region and a half-wave plate corresponding to the second region.

16. The electronic apparatus of claim 15, wherein the patterned retarder comprises a plurality of odd-numbered lines and a plurality of even-numbered lines, the transparent portion is on the plurality of odd-numbered lines, and the half-wave plate is on the plurality of even-numbered lines.

17. The electronic apparatus of claim 14, wherein
the patterned retarder comprises a first patterned retarder and a second patterned retarder on the first patterned retarder,
the first patterned retarder comprises a first quarter-wave plate corresponding to the first region, and a second negative quarter-wave plate corresponding to the second region, and
the second patterned retarder comprises quarter-wave plates corresponding to the first region and the second region.

18. The electronic apparatus of claim 14, wherein
the lenticular lens array has a first refractive index, and
the liquid crystal lenticular lens array has the first refractive index or a second refractive index depending on a polarization state of incident light.

19. The electronic apparatus of claim 14, wherein the lenticular lens array includes a plurality of lenticular lenses, and the plurality of lenticular lenses are tilted at an angle greater than 0° and less than 90° with respect to a horizontal direction.

20. The electronic apparatus of claim 14, wherein the lenticular lens array has a convex lens shape facing upward or a concave lens shape facing downward.
